(19) United States
(12) Patent Application Publication
(10) Pub. No.: US 2005/0249049 A1
(43) Pub. Date: Nov. 10, 2005

(54) Personal safety device

(76) Inventors: Keith Jarrett, Huntington Beach, CA (US); Patrick Fitzgerald, Redmond, WA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/070,682

(22) Filed: Mar. 1, 2005

Related U.S. Application Data
(60) Provisional application No. 60/549,239, filed on Mar. 2, 2004.

(51) Int. Cl. G04C 23/00

(52) U.S. Cl. 368/250

(57) ABSTRACT

A personal security device is disclosed that permits a person in distress to alert people adjacent the person that a problem has occurred. The device may include an alarm circuit that may be activated by the person in distress of when the device is removed from the person in distress. The alarm circuit may be an audible alarm (80-125 decibels) circuit, a visual alarm circuit, an odor alarm, an electronic signal generation circuit or may generate a tracking signal.

### PRIORITY CLAIM

This application claims priority under 35 USC 119(e) from U.S. Provisional Patent Application Ser. No. 60/549,239 filed on Mar. 2, 2004 and entitled “Personal Safety Device” which is incorporated herein by reference.

### FIELD OF THE INVENTION

The invention relates generally to a personal security device.

### BACKGROUND OF THE INVENTION

Various types of personal safety devices have been developed in the prior art. These safety device may be activated to emit an audible signal when an individual is in distress. These personal security devices are sized so that the user may wear the devise on one's wrist, ankle, or around one's neck. While these devices have been useful, there still remains a need for a personalized safety device. For example, a company called Angel Alert (see www.angelalert.net for the website and description of the product) sells an angel alert child distance monitor that permits a parent to detect when a child strays too far away from the parent. In operation, the device is separated into a child portion and a parent portion. The child portion is a transmitter that generates a signal that is received by the parent portion which is a receiver. An alarm sounds when the child wanders away from the parent which is determined based on the strength of the signal from the child portion of the device. The child portion also has a panic button. This device, however, is somewhat large. In addition, the device does not provide any functionality in addition to alarm feature. Furthermore, it cannot be used by a child that is not within the general vicinity of the parent. Thus, it is desirable to provide a personal safety device and it is to this end that the present invention is directed.

### SUMMARY OF THE INVENTION

Exemplary embodiments disclosed herein are directed to a personalized safety device. The security device is a convenient, readily accessible, and non-intrusive personal security device that is capable of emitting one or more warning signals to draw attention to a person, such as a child, in distress. In one embodiment, the device is worn on the wrist of the user. According to one embodiment, the personal safety device includes a sound system capable of generating an alarm of 80-125 decibels. In another embodiment, one or more light may be provided on the perimeter of the safety device. The safety device may be integral with a wrist watch according to one embodiment.

In use, the safety device may be worn on the user's wrist and is then activated. The alarm will sound if any unauthorized attempts are made to remove the device from the user. In addition, if the user is in distress, the device may be manually activated to emit one or more alarms. In accordance with the invention, should the user desire to remove the personal safety device, the user would need to deactivate the device by entering a code, performing a particular sequence of steps or the like.

Thus, in accordance with the invention, a watch is disclosed. The watch has a watch body and a watch module located within the watch body that displays a time of day. The watch also has an alarm circuit located within the watch body and a power source located in the watch body that provides power to the alarm circuit. The watch also has one or more alarm buttons located on the watch body wherein activation of the one or more alarm buttons generates an alarm signal so that a controller circuit, in response to the alarm signal, controls the alarm circuit to generate an audible alarm with a volume of between 80 and 120 decibels.

In accordance with another aspect of the invention, a personal security device is provided that has an alarm circuit located within the device and a power source located in the device that provides power to the alarm circuit. The device also has one or more alarm buttons located on the device wherein activation of the one or more alarm buttons generates an alarm signal and a controller circuit that, in response to the alarm signal, controls the alarm circuit to generate an audible alarm with a volume of between 80 and 120 decibels.

### BRIEF DESCRIPTION OF THE DRAWINGS

FIG. 1 is a diagram illustrating a side view of a watch embodiment of the personal safety device in accordance with the invention;

FIG. 2 is a close up top view of the watch embodiment shown in FIG. 1;

FIG. 3 is another view of the watch embodiment shown in FIG. 1;

FIG. 4 is a close-up side view of the watch embodiment shown in FIG. 1;

FIG. 5 is an exploded assembly diagram of the watch embodiment shown in FIG. 1;

FIG. 6 is a cut-away side view of the watch embodiment shown in FIG. 1;

FIG. 7 is a close up cut-away side view of the watch embodiment shown in FIG. 1;

FIG. 8A is a planar view of a chamber in the piezo element shown in FIG. 7;

FIGS. 8B and 8C are planar and cross sectional views of a piezo element in the watch shown in FIG. 7;

FIG. 9 is an exploded assembly of the buttons of the watch embodiment shown in FIG. 1; and

FIG. 10 is a diagram illustrating the circuitry used to implement a preferred embodiment of the invention.

### DETAILED DESCRIPTION OF A PREFERRED EMBODIMENT

The invention is particularly applicable to a personal security device implemented as a watch and it is in this context that the invention will be described. It will be appreciated, however, that the personal security device in accordance with the invention has greater utility as the teachings of the personal security device (and its circuitry and functionality) may be used for other implementations of the personal security device. A preferred embodiment of the watch embodiment of the personal security device may generate one or more alarms, is generally the size of a typical wrist watch and is a digital watch having various functions, such as a stopwatch, calendar and the like. In another embodiments, the watch may be an analog/digital watch or an analog watch. In all of the embodiments of the watch, the watch may be adapted for sports activity such that the watch is waterproof and/or shock resistant. The watch may be relatively slim and sized for children or sized for adult women and men. In yet another embodiment, the watch is designed for elderly people and may have, for example, larger buttons and numerals that are displayed. Thus, the watch may be implemented in different ways for different types of users and the modifications for the different implementations are within the scope of the invention.

The detailed description set forth below in connection with the appended drawings is intended as a description of exemplary embodiments and is not intended to represent the only forms in which the invention may be constructed and/or utilized. Thus, the description below sets forth the functions and the sequence of steps for constructing and operating the exemplary embodiments. However, it is to be understood that the same or equivalent functions and sequences may be accomplished by different embodiments that are also intended to be encompassed within the scope of the invention which is a personal security device. Now, a watch embodiment of the personal security device in accordance with the invention will be described.

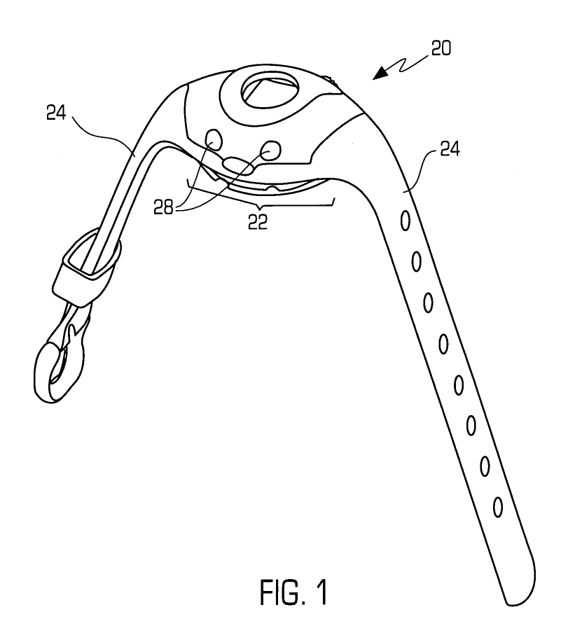

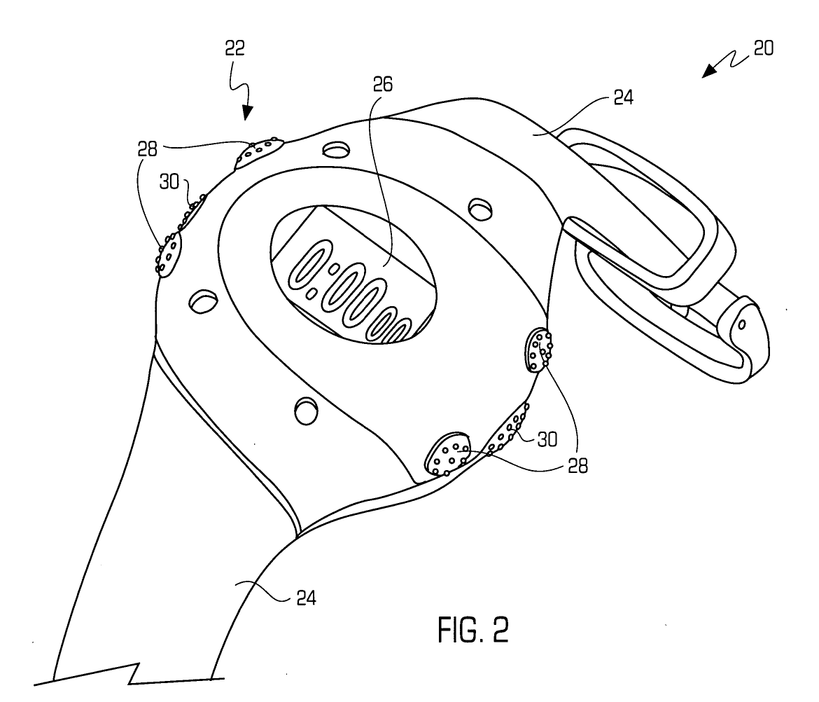

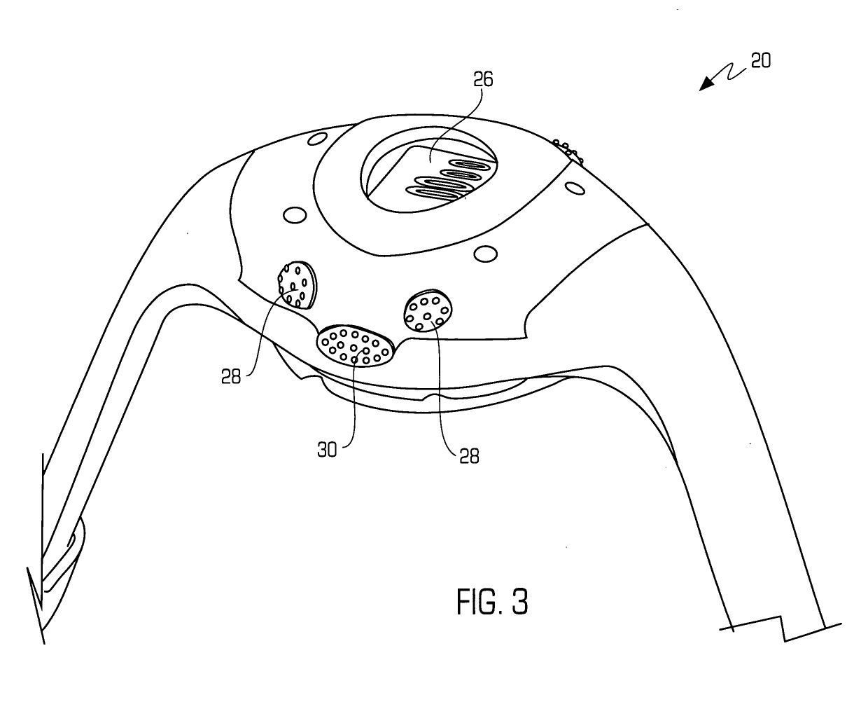

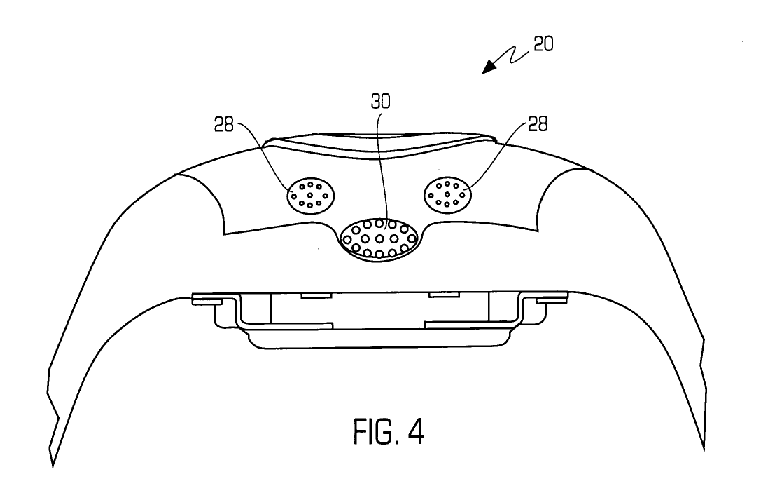

FIGS. 1-4 are diagrams illustrating a watch embodiment 20 of the personal safety device in accordance with the invention. In this embodiment, the watch is a typical digital watch that operates and has the functions of a typical digital watch. The watch has a watch body 22 with straps 24 attached to the body 22 so that the watch may be worn around the wrist of the user. The watch body may be made of different materials, but may be preferably made of a plastic material. The watch body 22 may further comprise a viewing port 26 through which the user views the digital readout of the time of the day or stopwatch (as shown in FIG. 2). The watch body may further comprise one or more feature buttons 28 that permit the user to control the operation of the watch as is well known. For example, one button may be pressed to provide light (back-lighting for example) to the watch while another button may be depressed to cycle the watch through its modes of operation, such as a time mode, a stopwatch mode, an alarm mode, etc. The watch also has a set of alarm buttons 30 which are preferably located on each side of the watch body as shown in FIG. 2. In accordance with the invention, when the person wearing the watch wishes the activate a loud alarm, such as when the user is threatened or needs to attract attention, the person can simultaneously depress both alarm buttons 30 for a period of time, such as 1 second, in order to activate the audible alarm. The exact locations of the alarm button(s) is not critical to the invention as the buttons may be located on each side of the watch body as set forth above, but the buttons also may be located on the face of the watch body or around the perimeter of the watch body. The watch may be powered by either a typical battery (such as in the preferred embodiment), solar power with a solar cell or by a combination of a battery and solar power.

In a preferred embodiment of the watch, the watch may emit an audible alarm that may be generated by a well known piezo speaker wherein the speaker is coupled to a helmholtz chamber that may amplify the sound output from the speaker. As those skilled in the art will appreciate, any other types of speakers known or later developed may be used with the personal security device to generate the audible alarm. The audible alarm in accordance with the invention preferably may be sufficiently loud to be heard for a two block radius. The personal security device may generate an audible signal with a volume of between 80 to approximately 125 decibels. The personal security device, such as the watch, may include a volume control for the audible signal so that, for example, the volume may be adjusted (to be louder or quieter) such that the sound level is at a safe level for a particular user, such as a child with sensitive hearing.

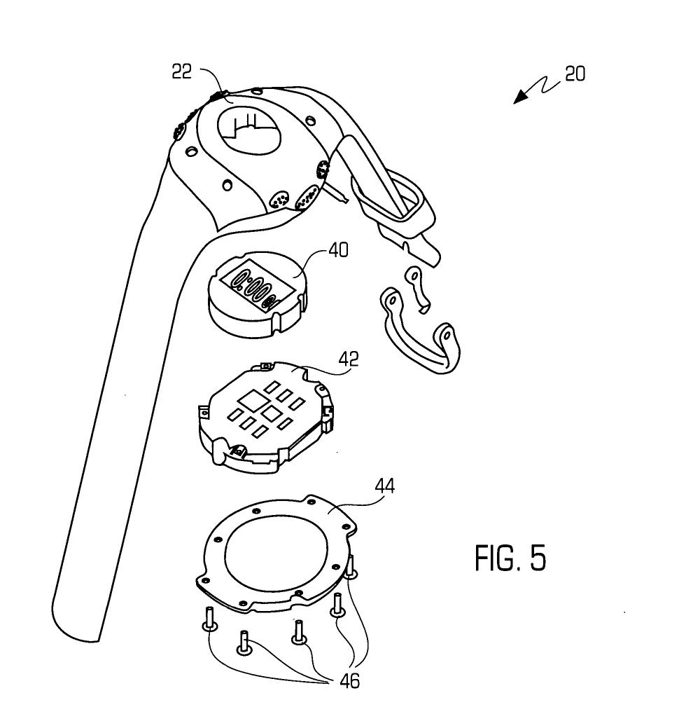

FIG. 5 is an exploded assembly diagram of the watch 20 shown in FIG. 1. As shown, the watch body 22 may house a watch module 40 and a printed circuit board (PCB) module 42 that are encased by a cover 44 which is held in place against the watch body 22 by one or more attachment mechanisms 46, such as screws as shown in FIG. 5.

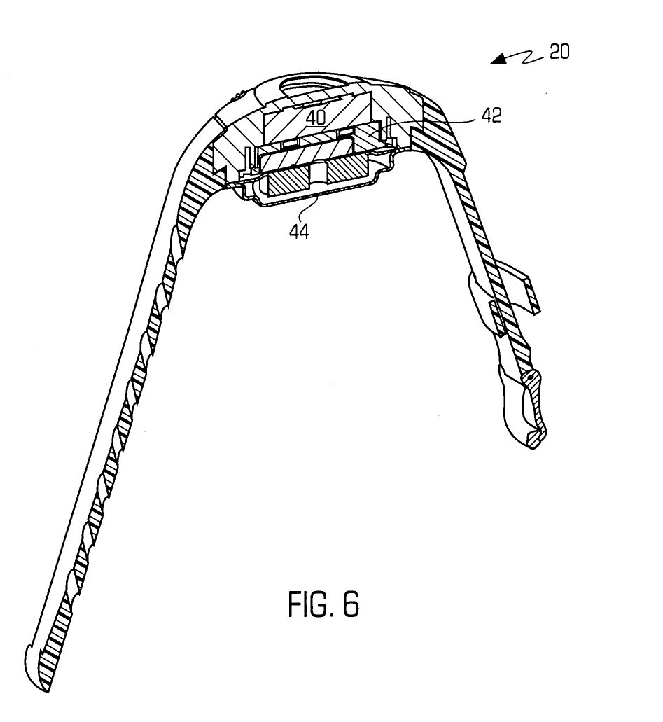

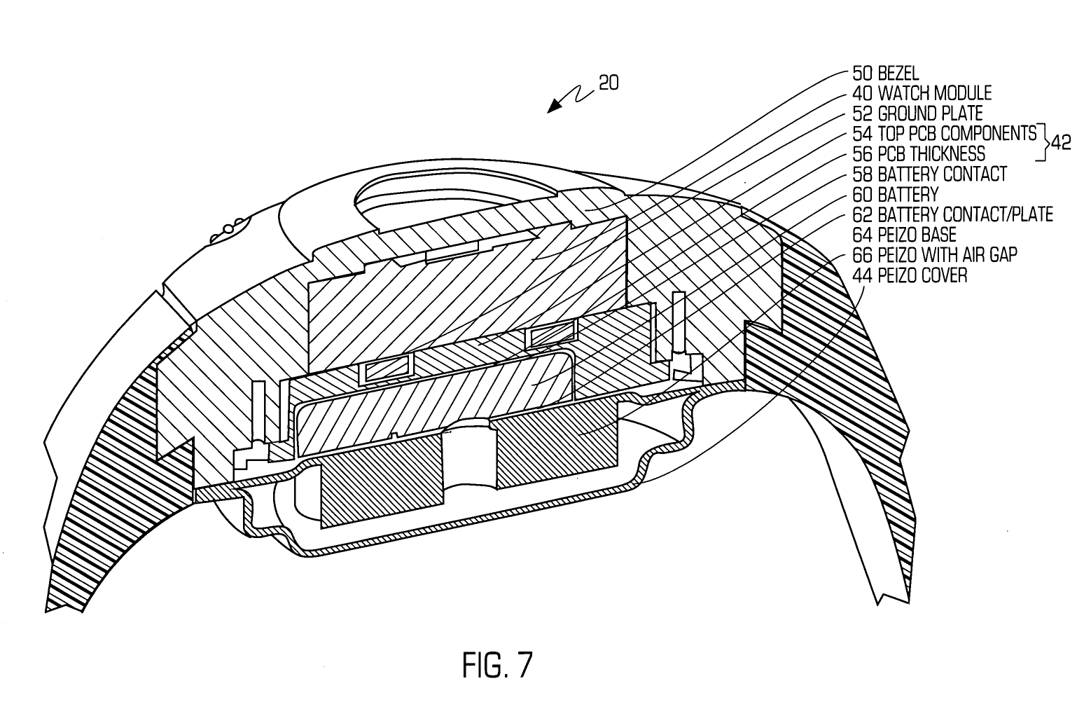

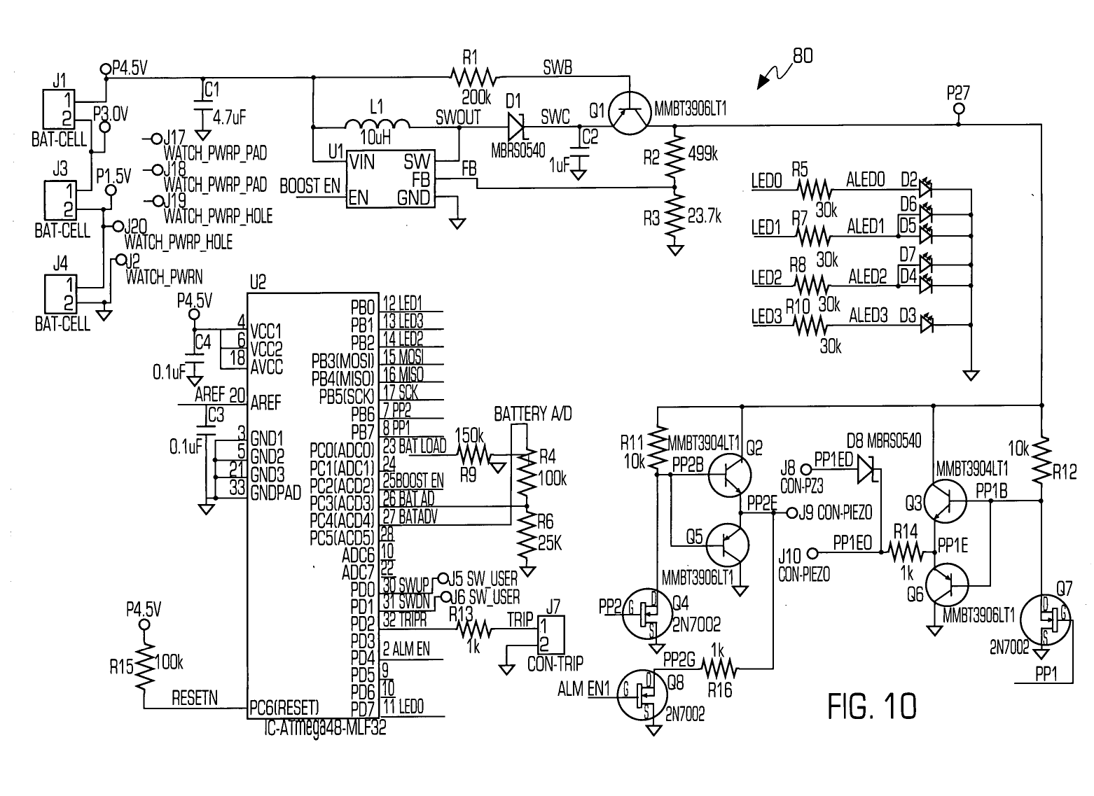

FIG. 6 is a cut-away side view of the watch embodiment shown in FIG. 1 and FIG. 7 is a close up cut-away side view of the watch embodiment shown in FIG. 1. The various elements of the watch 20 are shown stacked together. The watch has a bezel portion 50 under which is the watch module 40 which rests on a ground plate 52 that separates the watch module from the PCB module 42. The PCB module 42 further comprises one or more components 54 and a printed circuit board 56. The components 54 are shown and described below in more detail with reference to FIG. 10. A battery contact 58 sits between the PCB 56 and a battery 60 (e.g., LR44 size). A bottom battery contact/plate 62 is located underneath the battery. A base portion 64 is located adjacent to the battery plate 62. A piezo element 66 with an air gap (to form a Helmholtz chamber that amplifies the sound generated by the piezo element) is attached to the base portion. The air gap permits the piezo element to generate the audible sounds in accordance with the invention in a small area. The cover 44 covers the piezo element 66 to protect it and establish the boundaries of the air gap for the piezo element.

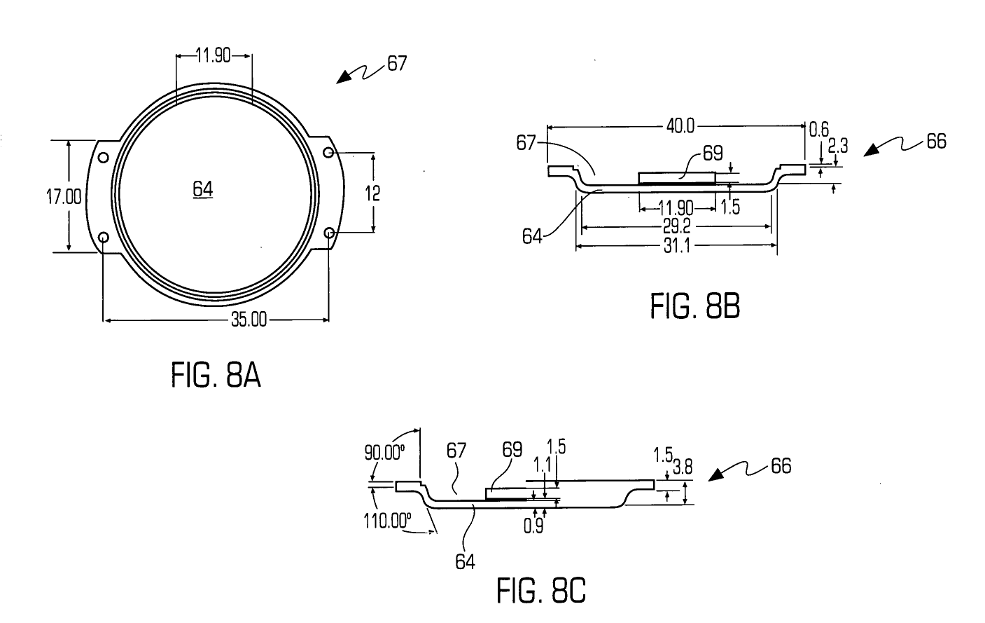

FIG. 8A is a planar view of the chamber for the piezo element 66 shown in FIG. 7. The chamber 67 has a shape that fits easily into the watch body 22, which in this case is circular. The piezo element 66 is a combination of a chamber and a sound generation element in the chamber. The chamber may be made of any suitable material including but not limited to copper, stainless steel, or ceramic. There are two holes in the chamber 67 that allow sound to travel out of the chamber more effectively, allowing a louder maximum volume for the alarm. While some typical piezo chambers have a hole in the base, it is preferable for this embodiment that there be a plurality of holes located on the sidewall (the holes are not shown). The holes may be about 12-15 mm in diameter, although the hole size may be adjusted according to the pitch of the sound that is generated, the desired volume, etc.

FIGS. 8B and 8C show a cross sectional view of the piezo element 66 and illustrate the placement of the sound generation element 69. The dimensions shown in FIGS. 8A, 8B, and 8C, which are in millimeters, are only exemplary and may be varied according to the design of the particular watch. In the embodiment shown, the sound generation element 69 is positioned near a center of the base 64.

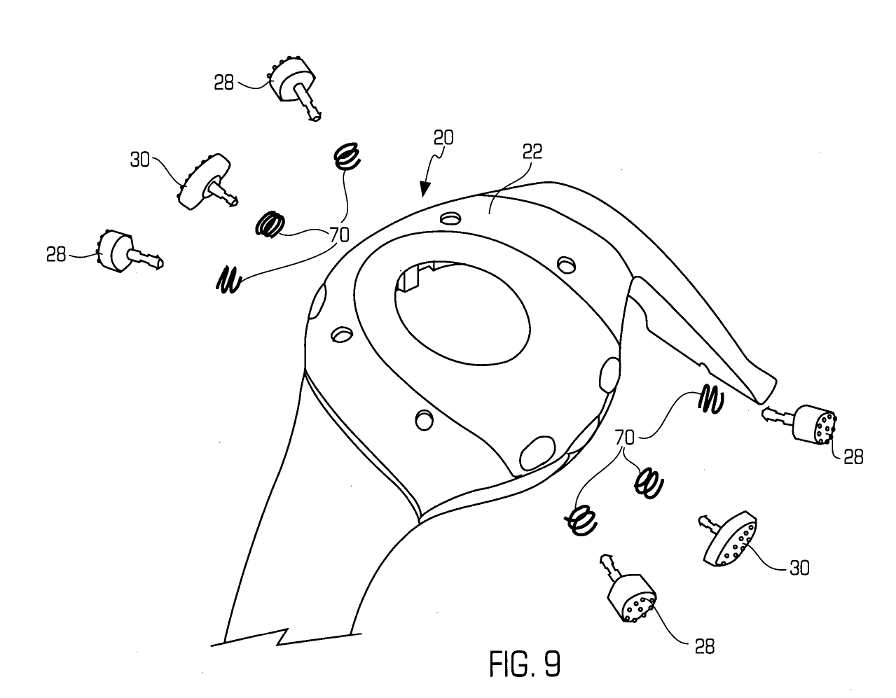

FIG. 9 is an exploded assembly of the buttons of the watch embodiment shown in FIG. 1 wherein the buttons 28, 30 are shown exploded from the watch body 22 with each button being depressably connected to the watch body by a spring element 70 as shown.

FIG. 10 is a diagram illustrating an example of circuitry 80 that may be used to implement a preferred embodiment of the invention. The circuitry may include a controller U2, such as an ATMEL ATmega48 8-bit microcontroller with programmable flash in a preferred embodiment, and a boost circuit U1, such as a Texas Instruments TPS61040 low power DC/DC boost converter in a preferred embodiment. The circuitry may be powered by one or more battery cells J1, J3 and J4 that together may provide one or more voltages to the circuits such as 1.5V, 3V and 4.5V in the preferred embodiment shown in FIG. 9.

The boost circuit U1 boosts the input DC voltage, such as 4.5V, to a boosted voltage that may be used to power the piezo element (shown above) that may be connected to piezo connectors J8, J9 and J10. In a preferred embodiment, an output voltage of approximately 27V is generated using the resistors shown in FIG. 10 wherein the output voltage, Vout=1.233×(1+R2/R3) as set forth in the datasheet of the TPS61040 boost converter which is available at the Texas Instrument website (http://focus.ti.com/lit/ds/symlink/tps61040.pdf) and which is incorporated herein by reference. The output voltage is used to drive the piezo element to generate the audible signal with a volume of 80-125 decibels.

The controller U2 controls the overall operation of the watch including the piezo element that generates the audible signal (using the PP2, ALM_EN and PP1 signals) and the boost circuit (using the BOOST_EN signal). As is well known, the controller may include firmware stored in the controller that is executed by a processor within the controller to control the generation the overall operation of the watch. For example, the controller also generates a the clock signals and controls the operation of one or more light sources using LED0, LED1, LED2 and LED3 signals that control LEDs that may be lit when the audible alarm is activated by the user. The controller and its execution may be influenced by actions of the user, such as the depression of a button that may generate signals that are input at pins 30 and 31 as shown in FIG. 10. Thus, the circuit 80 shown in FIG. 10 is a preferred implementation of the watch embodiment that performs typical watch functions such as displaying the current time as well as generating the audible alarm. The combination of the boost circuit shown in FIG. 10 (to generate the relative high voltage) with the piezo and air gap shown in FIG. 7 permits the watch to generate the audible signal in the range of 80-125 decibels.

As described above, the personal security device in accordance with the invention may generate an audible alarm. The personal security device may also generate a visual signal (See LEDs in FIG. 10) in combination with the audible alarm wherein the sources of light may be positioned at one or more corners of the personal security device or the entire perimeter of the personal security device may be illuminated. The lights may be of any color, but preferably may be red or amber colored. The lights may emit steady light or flash in a predetermined pattern. The light sources may be implemented using various well known technologies, such as LEDs in a preferred embodiment of the invention.

The personal security device in accordance with the invention may also include an odor alert system that generates an odor when activated by the user. For example, the personal security device may include a small canister that is capable of emitting a pungent or otherwise smelly odor. The personal security device may also emit an electronic signal such as an infrared or radio frequency signal that is transmitted to the local authorities or a monitoring station as another mechanism to generate an alarm. The personal security device may also include a tracking device, such as GPS-based or cellular phone based tracking system so that the personal security device may be tracked.

As shown above, the personal security device may include one or more straps or bands with a fastening mechanism to couple the device to a user's wrist, ankle, arm, leg, or the like. Once the user affixes the device to their body and sets the device, any unauthorized removal of the device will cause one or more of the alert systems to be activated. For example, if the band is cut or if the clasp is opened before disabling the device, one or more of the alarm signals will be activated. To implement this functionality, the personal security device may have one or more wires in the band that, when broken, will cause the one or more alarms to be generated. Alternatively, the personal security device may measure a change in a variable, such as, but not limited to, inductance, voltage, current or the like, so that, if the variable exceeds or drops below a predetermined value, the one or more alarms will be triggered in accordance with the invention. Alternatively, the personal security device may include an accelerometer or piezoelectric sensor to detect changes in acceleration or pressure on the device so that, when an individual attempts to grab and forcefully remove the device, the one or more alarms may be activated. In accordance with the invention, the one or more alarms may be deactivated by entering a code into the personal security device or by pushing one or more buttons on the device in a particular sequence.

In use, a child may wear the personal security device on his or her wrist when the device may be in the form of a watch and function like a watch, but also has various alert signals that may be activated by the child. Alternatively, the device may be used by any person of any age who would like a security device that will ward off would be attackers or signal that the person is in distress.

While the foregoing has been with reference to a particular embodiment of the invention, it will be appreciated by those skilled in the art that changes in this embodiment may be made without departing from the principles and spirit of the invention, the scope of which is defined by the appended claims.

1. A watch, comprising:
a watch body;
a watch module located within the watch body that displays a time of day;
an alarm circuit located within the watch body;
a power source located in the watch body that provides power to the alarm circuit;
one or more alarm buttons located on the watch body wherein activation of the one or more alarm buttons generates an alarm signal; and
a controller circuit that, in response to the alarm signal, controls the alarm circuit to generate an audible alarm with a volume of between 80 and 120 decibels.

2. The watch of claim 1, wherein the alarm circuit further comprises one or more light sources that generate a visual alarm.

3. The watch of claim 2, wherein the one or more light sources further comprise light emitting diodes.

4. The watch of claim 2, wherein the light sources are controller by the controller circuit to generate a predetermined pattern of visual signals.

5. The watch of claim 1, wherein the alarm circuit further comprises a mechanism to generate an odor when the alarm signal is activated.

6. The watch of claim 1, wherein the alarm circuit further comprises a transmitter that generates an electronic signal when the alarm signal is activated.

7. The watch of claim 1, wherein the alarm circuit further comprises a tracking circuit so that the watch is trackable when the alarm signal is activated.

8. The watch of claim 7, wherein the tracking circuit further comprises a global positioning system unit.

9. The watch of claim 7, wherein the tracking circuit further comprises a cellular-based tracking unit.

10. The watch of claim 1, wherein the alarm circuit further comprises a removal circuit that detects removal of the watch from the user and generates the alarm signal.

11. The watch of claim 10, wherein the removal circuit further comprises a wire embedded into a strap of the watch.

12. The watch of claim 1, wherein the alarm circuit further comprises a piezo element that generates sound waves and a Helmholtz chamber that amplifies the sound waves to generate the audible alarm.

13. The watch of claim 12 further comprising a boost circuit within the watch body that boosts the voltage generated by the power source to drive the piezo element.

14. The watch of claim 12, wherein the Helmholtz chamber comprises:
a base; and
a sidewall having at least one hole to allow sound to travel out of the Helmholtz chamber.

15. The watch of claim 1, wherein the power source further comprises one or more of a battery, a solar cell and a combination of a battery and a solar cell.

16. A personal security device, comprising:
an alarm circuit located within the device;
a power source located in the device that provides power to the alarm circuit;
one or more alarm buttons located on the device wherein activation of the one or more alarm buttons generates an alarm signal; and
a controller circuit that, in response to the alarm signal, controls the alarm circuit to generate an audible alarm with a volume of between 80 and 120 decibels.

17. The device of claim 16, wherein the alarm circuit further comprises one or more light sources that generate a visual alarm.

18. The device of claim 17, wherein the one or more light sources further comprise light emitting diodes.

19. The device of claim 17, wherein the light sources are controller by the controller circuit to generate a predetermined pattern of visual signals.

20. The device of claim 16, wherein the alarm circuit further comprises a mechanism to generate an odor when the alarm signal is activated.

21. The device of claim 16, wherein the alarm circuit further comprises a transmitter that generates an electronic signal when the alarm signal is activated.

22. The device of claim 16, wherein the alarm circuit further comprises a tracking circuit so that the device is trackable when the alarm signal is activated.

23. The device of claim 22, wherein the tracking circuit further comprises a global positioning system unit.

24. The device of claim 22, wherein the tracking circuit further comprises a cellular-based tracking unit.

25. The device of claim 16, wherein the alarm circuit further comprises a removal circuit that detects removal of the device from the user and generates the alarm signal.

26. The device of claim 25, wherein the removal circuit further comprises a wire embedded into a strap of the device.

27. The device of claim 16, wherein the alarm circuit further comprises a piezo element that generates sound waves and a Helmholtz chamber that amplifies the sound waves to generate the audible alarm.

28. The device of claim 27 further comprising a boost circuit within the device body that boosts the voltage generated by the power source to drive the piezo element.

29. The device of claim 27, wherein the Helmholtz chamber comprises:
a base; and
a sidewall having at least one hole to facilitate sound travel out of the Helmholtz chamber.

30. The device of claim 16, wherein the power source further comprises one or more of a battery, a solar cell and a combination of a battery and a solar cell.

31. The device of claim 16 further comprising a watch module.
